(19) United States
(12) Patent Application Publication
(10) Pub. No.: US 2007/0253870 A1
(43) Pub. Date: Nov. 1, 2007

(54) Specimen tube holder and shipping container

(75) Inventors: Patrick A. Weiss, Huntsville, AL (US); Flavio R. Ortigao, Huntsville, AL (US)

Correspondence Address: LANIER FORD SHAVER & PAYNE P.C., P O BOX 2087, HUNTSVILLE, AL, 35804, US

(73) Assignee: Operon Biotechnologies, Inc., Huntsville, AL (US)

(21) Appl. No.: 11/415,337

(22) Filed: May 1, 2006

(51) Int. Cl. B01L 9/00

(52) U.S. Cl. 422/104

(57) ABSTRACT

A shipping container/rack for shipping and holding of specimen or culture tubes is claimed. The invention consists of a hollow housing with a plurality of wells for holding tubes upright during processing of their contents, and separate brackets for securing the tubes during shipment. The housings are joinable front-to-back for creating larger tube storage rack, and housings are also stackable one atop another. The housing provides a secure, shock-proof shipping container during shipping of filled specimen tubes and a convenient tube rack for multiple tubes during insertion, extraction, and processing of tube contents.

### FIELD OF THE INVENTION

The present invention relates generally to a specimen or culture tube holder. More particularly, the invention relates to a shipping container for transporting specimens/cultures that alternatively serves as a tray for holding specimen tubes upright.

### BACKGROUND OF THE INVENTION

Specimen tubes must be held upright during insertion/extraction of or processing of their contents. Additionally, the tubes need to be aligned uniformly if they are to be used with automatic analytical equipment. Many different types of tube holders/racks exist to accomplish the task of holding multiple tubes in the proper position. For example, U.S. Pat. No. 5,996,818 discloses and claims a specimen tube rack for securely holding multiple tubes upright.

When specimens in their tubes are to be shipped over distances, the tubes must be positively retained in a secure and shock-proof shipping container. There are different ways to package specimen or culture tubes containing specimens for shipment, in specially-designed cardboard containers with dividers for individual tubes, for example.

It would be desirable to have a shipping container that would securely retain and hold filled tubes during shipment, that would also, upon reaching its destination, serve as a tube rack for vertical processing of tube contents.

It would also be desirable to have a set of racks arranged in modular fashion so that a plurality of racks so arranged can be handled as a single rack.

It would also be desirable for the shipping containers to be stackable during shipment and/or storage.

### SUMMARY OF THE INVENTION

It is therefore an object of the present invention to provide a specimen tube holder which can perform both the functions of (1) holding multiple tubes upright and (2) provide shock-proof constraint for tubes during shipping.

It is another object of the present invention to provide a specimen tube holder adapted to join with other tube holders to create a larger tube rack.

It is yet another object of the present invention to provide for stacking of the tube holders during shipment or when empty.

The present invention achieves these objectives by providing a housing with a plurality of wells for receiving and retaining tubes in spaced apart vertical orientation, which housing also provides separate brackets for securely holding tubes during shipment. Multiple housings are joinable front to back and are stackable one atop another.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### DESCRIPTION OF THE DRAWINGS

FIG. 1 is a top perspective view of one embodiment of an empty tube holder.

FIG. 2 is a top perspective view of one embodiment of the present invention, filled with vertical tubes.

FIG. 3 is a bottom perspective view of one embodiment of the present invention.

FIG. 4 is a top perspective view of one embodiment of the present invention, filled with horizontal tubes in shipping configuration.

FIG. 5 is a top elevational view of one embodiment of the invention.

FIG. 6 is a top view of multiple tube holders joined together front-to-back.

FIG. 7 is a side view of two tube holders stacked one on top of the other, with portions removed for the purposes of clarity.

FIG. 8 is a bottom elevational view of one embodiment of the invention.

Repeat use of reference characters throughout the present specification and appended drawings is intended to represent the same or analogous features or elements of the invention.

### DETAILED DESCRIPTION

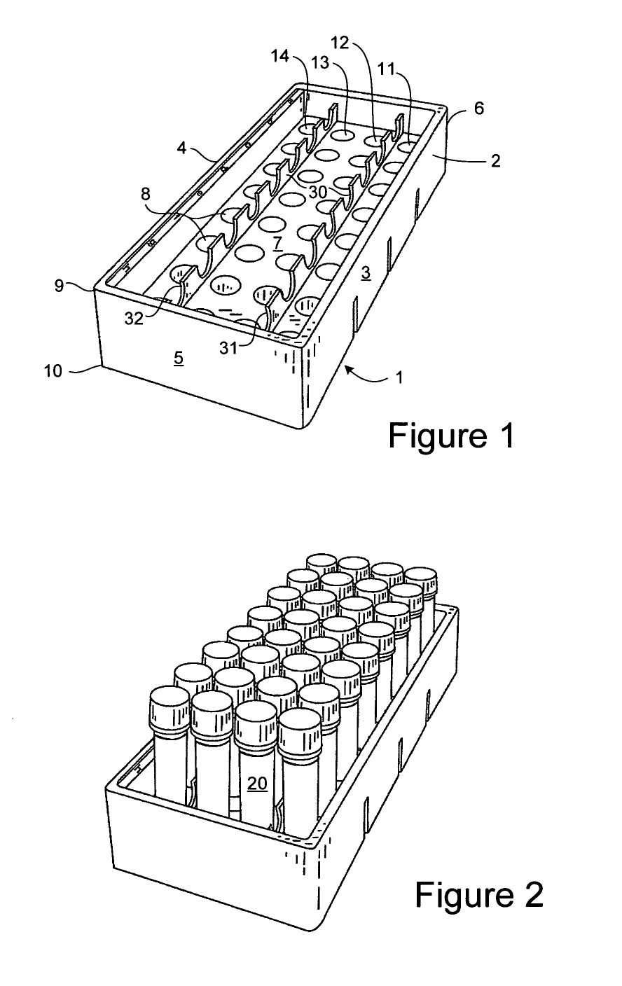

Referring to FIG. 1, the specimen tube rack/shipping container of the present invention is designated generally at 1 and includes a housing 2 for supporting a plurality of specimen tubes. Housing 2 is generally hollow and includes forward and rearward walls 3 and 4, respectively, side walls 5 and 6, and top and bottom edges 9 and 10, respectively. A recessed horizontal shelf 7 is situated between the top and bottom of the housing. A plurality of wells 8 are formed into the shelf 7, spaced apart, the wells extending downwardly into the housing 2, each well 8 adapted to receive a tube 20 and hold the tube in an upright, vertical position, as is shown in FIG. 2.

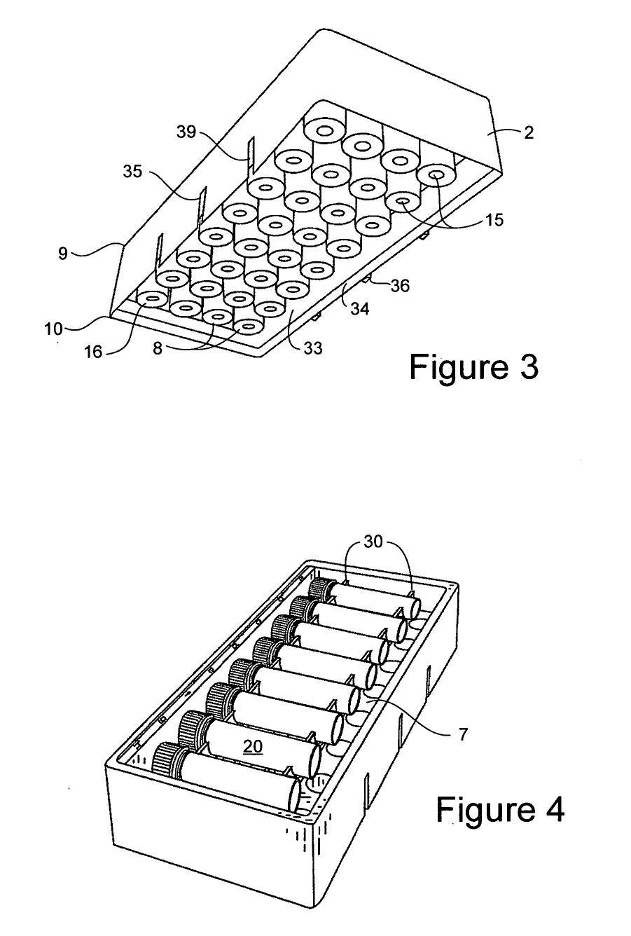

A bottom perspective view of one embodiment of the invention showing the undersides of the wells 8 is provided in FIG. 3. In this embodiment, the bottom portion 16 of each well 8 has a through hole 15 that allows for easier insertion and removal of the tubes.

As shown in FIG. 1, the wells 8 in the illustrated embodiment are arranged in uniform rows and columns parallel to the front and sides of the housing 2. In the embodiment illustrated in FIG. 1, there are four (4) rows of wells, labeled 11-14, respectively, from front to back. The illustrated embodiment provides eight (8) columns of wells, for a total of twenty-four (24) wells. Other numbers and configurations of columns and rows of wells are also possible within the scope of the present invention.

Shelf 7 also contains a plurality of brackets 30 formed on its top side in such a manner as to retain multiple tubes horizontally, spanning columns of wells 8 as illustrated in FIG. 4. The brackets hold the tubes firmly and securely so that the housing 2 can be used as a shipping container for filled specimens. In the embodiment shown in FIG. 1, the brackets 30 are arranged in two parallel rows 31 and 32 positioned between the well rows 11 and 12 and between well rows 13 and 14, respectively. In this embodiment, each bracket row consists of a thin wall with semi-circular openings sized slightly larger than the external dimensions of the tubes 20, so that the tubes will “snap fit” into the bracket openings and be retained by the brackets. The two rows of brackets are spaced sufficiently apart that the brackets contact the tubes 20 near their top and bottom ends to firmly hold the tubes in place. In the illustrated embodiment, the maximum number of tubes that can be accommodated by the brackets for horizontal shipment is equal to the number of columns of wells, for example, eight (8) in the illustrated embodiment, although other embodiments may have different arrangements and may accommodate different numbers of tubes.

As is illustrated in FIG. 4, the depth of the shelf 7 is sufficient so that the tubes 20 do not protrude beyond the top edge of the housing 2.

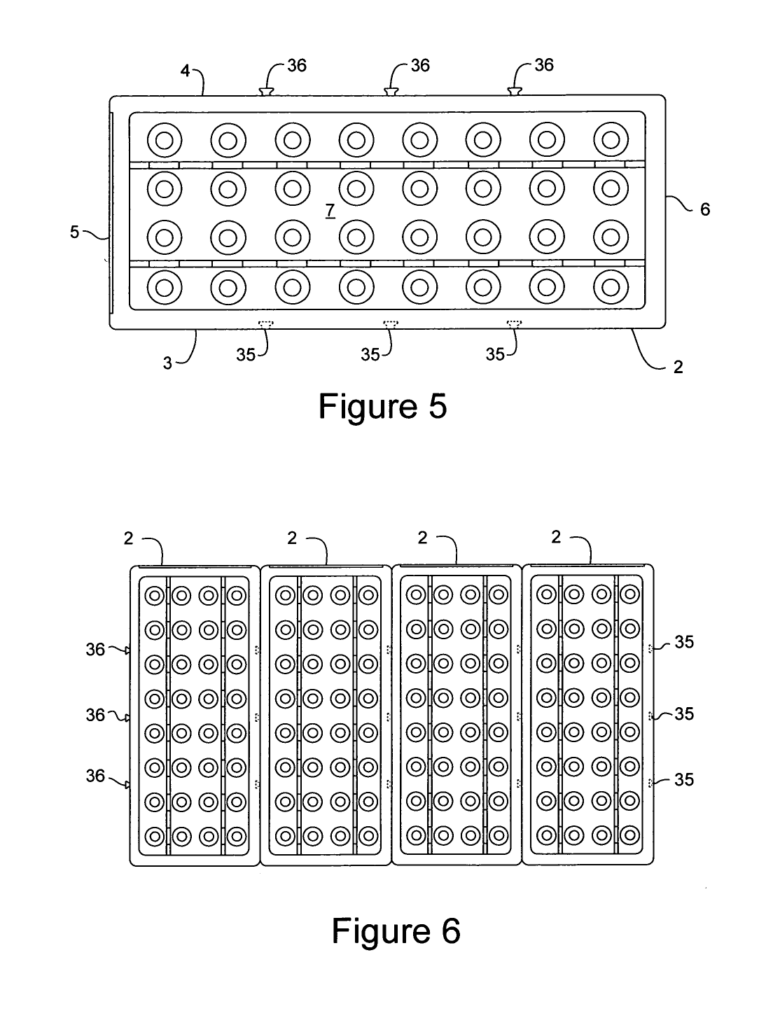

Multiple specimen tube holders can be joined front to back to (1) minimize the footprint of the holders during shipping and/or (2) provide a larger tube holder for use with vertical tubes. To enable joining of the housings 2 together, the forward wall 3 has vertically-oriented female slots 35 and the rear wall 4 has vertically-oriented male protrusions 36, as illustrated in the top view of FIG. 5. The male protrusions 36 slidably mate into the female slots 35 to join housings 2 together, front to back. FIG. 6 illustrates four (4) housings 2 joined together in this manner.

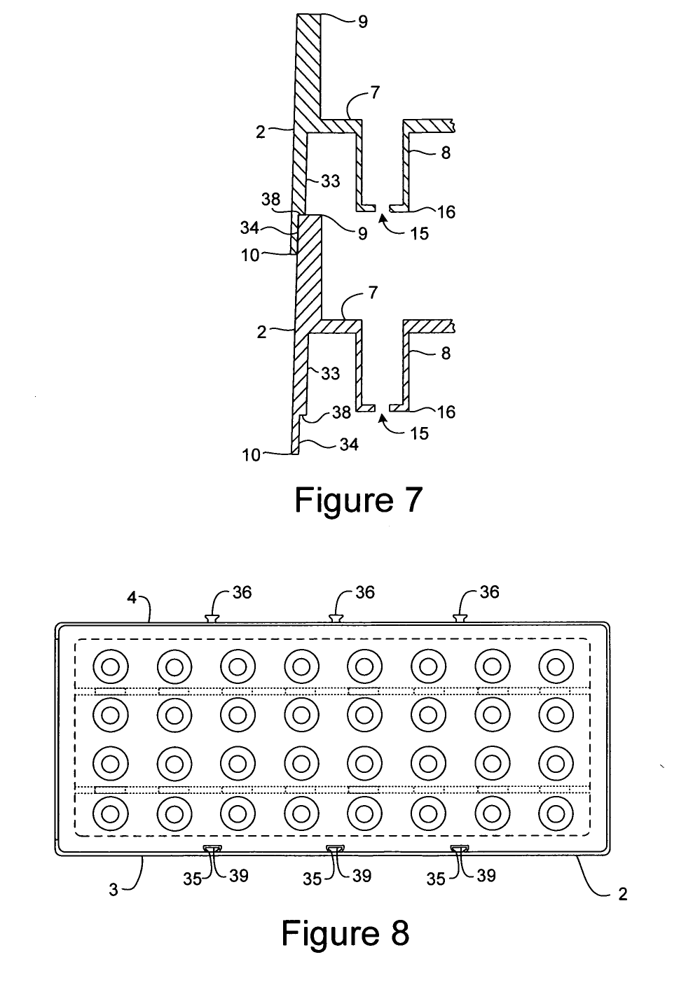

In addition, the tube holders are stackable, so that multiple tube holders can be shipped or stored with an efficient use of space. The tube holders may be stacked either when they are empty or when they are loaded with horizontally-retained tubes. As can be seen in FIGS. 3 and 7, the bottom inside surface 33 of the housing 2 has a “stepped” lip 34 that is thinner than the housing wall. Further, the bottom edge 10 of the housing is slightly larger than the top edge 9, i.e., the walls of the housing are somewhat flared, allowing the bottom edge 10 of housing 2 to fit over and slidably mate with the top edge 9 of another tube holder, as illustrated in FIG. 7, a partial side view of two stacked tube holders. In operation, when one tube holder is stacked on top of another, the lip 34 of the top housing is fitted over the top edge 9 of the bottom housing and pushed down until the horizontal step 38 of lip 34 rests against the top edge 9 of the bottom housing. As can be seen in FIG. 7, the bottom portion 16 of the wells does not extend beneath the horizontal step 38, which configuration was designed to prevent the bottom portion of the wells in one stacked tube holder from interfering with any horizontally-retained tubes that may be in the tube holder beneath it. In other words, when multiple tube holders are stacked, the bottom portions 16 of the wells do not extend beneath the top edge 9 of the underlying tube holder.

Although the back walls 39 of the female slots 35 extend into the interior of the housing 2, as illustrated in FIGS. 8 and 3, they do not interfere with the stacking of the housings, because the back walls 39 of the slots do not extend beneath the horizontal step 38 (i.e., into the lip area).

For shipment of specimen tubes, multiple tubes 20 are snapped into place in the brackets 30. The top edge 9 of the housing may be covered with foil or some other material, though no covering is required. Multiple housings may be stacked on top of one another

In one embodiment, the tube holder is designed to hold 1.5 mL specimen tubes, though other sizes of tube holders can be fabricated to accommodate different sizes of tubes without departing from the scope of the present invention. The housing 2 may be fabricated from any number of moldable materials, including resins such as polyethylene or various plastic materials.

As described above and shown in the associated drawings, the present invention comprises a specimen/sample tube shipping container that alternatively can be used as a vertical tube holder. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A specimen tube holder/shipping container for storage and shipment of a plurality of specimen tubes, comprising:
a housing with a hollow interior disposed within top and bottom portions, forward and rearward walls, and opposing end walls;
a horizontal shelf disposed between the top and bottom portions, the shelf comprising an array of individual wells adapted to retain individual tubes in spaced apart, vertical orientation; and
a plurality of brackets formed on the shelf adapted to frictionally secure a plurality of tubes in horizontal position.

2. The specimen tube holder/shipping container of claim 1, wherein the array of individual wells is arranged in rows parallel to the forward wall and columns perpendicular thereto.

3. The specimen tube holder/shipping container of claim 1, wherein each well comprises cylindrical walls and a bottom.

4. The specimen tube holder/shipping container of claim 2, wherein the plurality of brackets comprises a plurality of aligned parallel rows of vertically-disposed semi-circular brackets formed between rows of wells.

5. The specimen tube holder/shipping container of claim 4, wherein the plurality of aligned parallel rows of vertically-disposed semi-circular brackets comprises two rows of brackets.

6. The specimen tube holder/shipping container of claim 2, wherein the rows are spaced uniformly apart and the columns are spaced uniformly apart.

7. The specimen tube holder/shipping container of claim 3, wherein the bottom of each well has a through hole disposed therein.

8. The specimen tube holder/shipping container of claim 1, wherein the shelf is disposed about midway between the top portion and the bottom portion of the housing.

9. The specimen tube holder/shipping container of claim 1, wherein the bottom portions of the walls of the housing comprise a stepped lip for slidably mating with the top portions of the walls of another housing for stacking of the housings.

10. The specimen tube holder/shipping container of claim 9, wherein the bottom portions of of the wells do not protrude beneath the stepped lip.

11. The specimen tube holder/shipping container of claim 1, wherein the lower portion of the walls has a bottom edge configured to anchor with the top edge of an underposed similarly constructed housing thereby enabling a stacking of two or more of the housings.

12. The specimen tube holder/shipping container of claim 1, wherein the forward and rearward walls of the housing comprise mating means for joining multiple housings front to back.

13. The specimen tube holder/shipping container of claim 1, wherein the forward wall of the housing comprises male protrusions and the rearward wall of the housing comprises female slots such that the forward wall of one housing is joinable with the rearward wall of another housing.

14. The specimen tube holder/shipping container of claim 1, wherein the distance between the shelf and the top edges of the housing is greater than the diameter of the specimen tubes.

15. The specimen tube holder/shipping container of claim 2, wherein the brackets are disposed so that tubes retained by the brackets are aligned parallel to and overlying the columns of wells.

16. The specimen tube holder/shipping container of claim 15, wherein the maximum number of tubes that can be retained by the brackets is equal to the number of columns.

17. A specimen tube holder/shipping container for storage and shipment of a plurality of specimen tubes, comprising:
a housing with a hollow interior disposed within top and bottom portions, forward and rearward walls, and opposing end walls;
a horizontal shelf disposed between the top and bottom portions and connecting the forward and rearward walls and opposing end walls, the shelf comprising a plurality of rows of individual wells adapted to retain individual tubes in spaced apart, vertical orientation, wherein each well comprises cylindrical walls and a bottom; and
a plurality of aligned parallel rows and columns of vertically-disposed semi-circular brackets formed between rows of wells adapted to frictionally secure tubes for horizontal shipment of tubes.
